(19) United States
(12) Patent Application Publication
(10) Pub. No.: US 2011/0185002 A1
(43) Pub. Date: Jul. 28, 2011

(54) DEFINITION OF UNIVERSAL CONSTANTS BY POSITIVE INTEGERS

(76) Inventor: WILLIAM EUGENE HODGE, Lumby (CA)

(21) Appl. No.: 12/755,681

(22) Filed: Apr. 7, 2010

Related U.S. Application Data
(60) Provisional application No. 61/297,740, filed on Jan. 23, 2010.

(51) Int. Cl. G06F 17/11

(52) U.S. Cl. 708/446; 703/2

(57) ABSTRACT

A method is given to facilitate discovery of the positive integers which may be the numerator and denominator which form the basis of some universal constants. Solutions are given for both π, the ratio of the circumference of a circle to its diameter, and ε, the base of the natural logarithm. A short computer code is provided as a simple tool for finding the two integers if they exist. It is suggested that reduction of these integers to the one or more primary numbers of which they are composed might be a useful tool in the quest to find a link between the separate physical models of the universe.

The method described herein is believed to be an advance on the current way of using real numbers to express the value of Universal Constants in mathematical physics. For example the value of π, the ratio of the circumference of a circle to its diameter, is give to an accuracy of six decimal places as 3.141593. Similarly the value of ε, the base of the natural logarithm, is given to the same accuracy as 2.718280. What is disclosed here is an approach which attempts to express these and other physical non-dimensional constants purely in terms of positive rational numbers raised, where necessary, to the power of a positive integer.

Approach to Solution

If the desired conclusion that Universal Constants, designated by “C” here, are in reality simply the quotient of positive integers, designated here as “K” and “L” raised to some power “N”, then the following equation should yield the precise value of such entities as π and ε, and all other mathematical physics constants which are meaningful.

C^{N}=K/L

In order to find out if this concept had any substance, a short computer program was written to facilitate calculation of multiple ranges of K, Land N. The FORTRAN code for this program is given later.

Results so Far

It was discovered that:
π is identical with 355/113
   and,
ε is identical with (5403/269)^{1/3}

Furthermore, it was realized that each of these numbers were either Prime Numbers (hereinafter “PN”) of a product of two PNs.
113 is a PN
269 is a PN
355=5*71
5403=3*1801
   where 3, 5, 71 and 1801 are all PNs.

Consequently, using a notation where PN1 designates the integer 1, and PN2 represents the second PN, and so on, the Universal Constants used above may be written as follows:

π=PN4*PN21/PN31

and

ε=(PN3*PN280//PN58)^{1/3}

where
PN3=3
PN4=5
PN21=71
PN31=113
PN58=269
PN280=1801

These findings suggest that π is one-dimensional since the value of N=1, and which seems reasonable because this constant is used to define the ratio of two lengths. It is not obvious yet why ε is raised to the power of N=⅓; perhaps this suggests it belongs in the three-dimensional realm/domain.

A second implication is possibly more profound inasmuch as it seems Nature may uses a sequence of numbers which are Prime only, skipping over the integers we use to fill the gaps between them. Our convention of having a sequence of equally spaced numbers may, in reality, be a figment of our imagination—a convenience for us, but a way of going about thing which Nature may dispense with as a redundancy. After all, all integers between PNs can be made from the product of earlier PNs.

Some Possible Uses

If the foregoing reasoning has any merit it is possible that this idea that Universal Constants are the simple product of PNs (sometimes raised to the power of another PN) then:

By using the symbol “PNJ”, where “J” here is used to represents the numerical sequence of that PN in the PN series, rather than the common practice of equating them to a Real number, it may be found that a particular PNJ occurs in more than one Universal Constant, thereby relating two or more Universal Constants in a way formerly escaping attention. In the extreme, it may help cross-relate the constants of Gravity, Light Speed, Electro-magnetic, Strong and Weak Forces in an enlightening way.

Intuitively, or perhaps favouring Plato over Aristotle, it is tempting to suppose that the approach of evaluating Nature's constants using Prime Numbers is bound to give precise values; and consequently, this approach could provide a means from calibrating the laboratory equipment used to determine them at present.

FORTRAN Code

PROGRAM UNIVCONS

```
* Written January 21st 2010 to find out if there is a root or power
* relationship which would allow Universal Constants to be computed
* from the ratio of two Integers
    OPEN(6,FILE=‘UCOUT’,STATUS=‘NEW’)
    WRITE(*,*)‘Input published value of non-dimensional constant’
    READ (*,*) CONST
    WRITE(*,*)‘Input Power to use’
    READ (*,*) NP
    WRITE(6,5010) NP
5010 FORMAT(10X,I5)
5020 FORMAT(5X,I5,F20.6)
    REALC=1
      DO 222 M=1,NP
    REALC=CONST*REALC
  222 CONTINUE
    DO 111 I=1,1000
    A=I*REALC
    WRITE(6,5020)I,A
  111 CONTINUE
  999 STOP
    END
```

### CROSS-REFERENCE TO RELATED APPLICATIONS

This application claims priority under 35 U.S.C. 119(e) to U.S. Provisional Patent application No. 61/297,740 filed Jan. 23, 2010, the disclosure of which is incorporated herein by reference.

I claim:

1. A method to facilitate discovery of the positive integers which may be the numerator and denominator which form the basis of some universal constants.

2. A method which might be a useful tool in the quest to find a link between the separate physical models of the universe.

3. A computer code to facilitate discovery of the positive integers which may be the numerator and denominator which form the basis of some universal constants.
